(19) United States
(12) Patent Application Publication
(10) Pub. No.: US 2020/0177412 A1
(43) Pub. Date: Jun. 4, 2020

(54) MONITORING DEVICE, MONITORING SYSTEM, AND COMPUTER READABLE STORAGE MEDIUM

(71) Applicant: Panasonic Intellectual Property Management Co., Ltd., Osaka (JP)

(72) Inventors: MASATO TANABE, Kanagawa (JP); YOSHIHARU IMAMOTO, Kanagawa (JP); JUN ANZAI, Kanagawa (JP)

(21) Appl. No.: 16/783,487

(22) Filed: Feb. 6, 2020

Related U.S. Application Data
(63) Continuation of application No. PCT/JP2018/025740, filed on Jul. 6, 2018.

(30) Foreign Application Priority Data
Aug. 30, 2017 (JP) 2017-165141

(51) Int. Cl. H04L 12/40; H04L 12/28; G05D 1/00; B60R 16/023; H04L 29/08

(52) U.S. Cl. CPC H04L 12/40013; H04L 12/2881; G05D 1/0088; H04L 2012/445; H04L 67/12; H04L 2012/40215; B60R 16/023

(57) ABSTRACT

A monitoring device is one of a plurality of monitoring devices to be attached to mobility. The monitoring device is configured to monitor an abnormal state of a first object to be monitored. The monitoring device includes a receiver and a controller. The receiver is configured to receive a result of detection of an abnormality detected by another monitoring device that monitors an abnormal state of a second object to be monitored that is different from the first object to be monitored. The controller is configured to change a process to be performed by the monitoring device, according to the result of detection of the abnormality detected by the other monitoring device.

### RELATED APPLICATIONS

This application is a continuation of PCT International Application No. PCT/JP2018/025740, filed on Jul. 6, 2018, which claims the benefit of foreign priority of Japanese patent application 2017-165141 filed on Aug. 30, 2017, the contents all of which are incorporated herein by reference.

### BACKGROUND

### 1. Technical Field

The present disclosure relates to a data processing technology, and particularly relates to a monitoring device, a monitoring system, and computer readable storage medium.

### 2. Background Art

In recent years, a vehicle includes a plurality of electronic devices and a plurality of network (NW) domains. Each of the plurality of electronic devices may have a security function. The electronic devices attached to the vehicle may include, for example, (1) entry-point devices, such as an in-vehicle infotainment (IVI) device and a telematics control unit (TCU), (2) network devices, such as a gateway (GW) and an Ethernet switch (“Ethernet” is a registered trademark), and (3) electronic control units (hereinafter referred to as “ECUs”) that control terminal systems in the vehicle.

### SUMMARY

The present disclosure suitably controls processes related to security of mobility, such as a vehicle.

A monitoring device according to an aspect of the present disclosure is one of a plurality of monitoring devices to be attached to mobility. The monitoring device is configured to monitor an abnormal state of a first object to be monitored. The monitoring device includes a receiver and a controller. The receiver is configured to receive a result of detection of an abnormality detected by another monitoring device that monitors an abnormal state of a second object to be monitored that is different from the first object to be monitored. The controller is configured to change a process to be performed by the monitoring device, according to the result of detection of the abnormality detected by the other monitoring device.

A monitoring system according to another aspect of the present disclosure includes a first monitoring device and a second monitoring device. The first monitoring device is to be attached to mobility. The first monitoring device is configured to detect whether or not a first object to be monitored is in an abnormal state, and is configured to transmit, to the second monitoring device that monitors a second object to be monitored that is different from the first object to be monitored, a result of detection of an abnormality. The second monitoring device is to be attached to the mobility. The second monitoring device is configured to receive the result of detection of the abnormality transmitted from the first monitoring device, and is configured to change a process to be performed by the second monitoring device, according to the result of detection of the abnormality.

Any combination of the above components, and expressions of the present disclosure are converted to a computer program, a recording medium that records the computer program, and mobility, such as a vehicle to which the monitoring device is attached. The computer program, the recording medium that records the computer program, and the mobility, such as a vehicle to which the monitoring device is attached are also useful as aspects of the present disclosure.

The present disclosure suitably controls processes related to security of mobility, such as a vehicle.

### BRIEF DESCRIPTION OF DRAWINGS

FIG. 1 schematically illustrates a configuration of a vehicle according to an exemplary embodiment.

FIG. 2 is a block diagram that illustrates a functional configuration of a controller area network (CAN) monitoring ECU in FIG. 1.

FIG. 3 is a flowchart that illustrates operations of the CAN monitoring ECU in FIG. 1.

FIG. 4 illustrates an example of switch between operations of an IVI device in FIG. 1.

FIG. 5 illustrates an example of switch between operations of an Ethernet-network monitoring ECU in FIG. 1.

FIG. 6 illustrates an example of switch between operations of the CAN monitoring ECU in FIG. 1.

FIG. 7 illustrates an example of switch between operations of an IVI device in a first example of modifications.

FIG. 8 illustrates an example of switch between operations of an IVI device in a second example of the modifications.

FIG. 9 is a block diagram that illustrates a functional configuration of a CAN monitoring ECU in a third example of the modifications.

FIG. 10 illustrates an example of switch between operations of an IVI device in the third example of the modifications.

### DETAILED DESCRIPTION OF PREFERRED EMBODIMENTS

Prior to a description of an exemplary embodiment of the present disclosure, problems of conventional technologies will briefly be described. It is conceivable that security functions are provided to a plurality of electronic devices attached to a vehicle. The security functions each include a monitoring function that monitors an electronic device to which the monitoring function is provided, or monitors a NW. Further, when the monitoring functions detect an attack, a process is needed that allows the vehicle to safely operate. However, each of the electronic devices monitors a limited range. Further, the monitoring functions may detect a wrong attack. Therefore, if each of the monitoring devices performs a process that corresponds to an attack detected by the monitoring device, control may be excessive in view of states of the whole vehicle.

Prior to a description of a detailed configuration of the exemplary embodiment, an outline of a configuration of the exemplary embodiment will be described. A plurality of monitoring devices are attached to a vehicle in the exemplary embodiment. The plurality of monitoring devices monitor states of respective different subjects (also referred to as components of the vehicle). Each of the monitoring devices monitors a limited range. Further, there is a certain possibility that each of the monitoring devices detects a wrong abnormality in an object to be monitored although the object to be monitored is actually normal. Therefore, if each of the monitoring devices performs a process that disables an attack detected by the monitoring device and a process that allows a vehicle to be safe (also referred to as a “fail-safe process”), based on a result of monitoring performed by the monitoring device, the disablement process and the fail-safe process may be excessive for states of the whole vehicle.

In a vehicle in the exemplary embodiment, a plurality of monitoring devices detect states of respective objects to be monitored, and notify, to each other, the states of respective objects to be monitored. Thus, each of the monitoring devices can refer to states of the vehicle that cannot be grasped itself. Therefore, each of the monitoring devices can appropriately perform data processing related to security of the vehicle, based on states of the vehicle that cannot be grasped itself. Further, each of the monitoring devices appropriately adjusts a form of the data processing, or appropriately switches between forms of the data processing, based on the states of the vehicle that cannot be grasped itself.

In the description below, a normalcy in an object to be monitored includes a state in which the object to be monitored is not attacked by a device outside the object to be monitored (e.g. malicious frames). Further, a normalcy in an object to be monitored includes a state in which firmware that is legitimate and has not been tampered runs. Further, an abnormality in an object to be monitored includes a state in which the object to be monitored is attacked by a device outside the object to be monitored (e.g. malicious frames). Further, an abnormality in an object to be monitored includes a state in which malicious firmware or has been tampered runs.

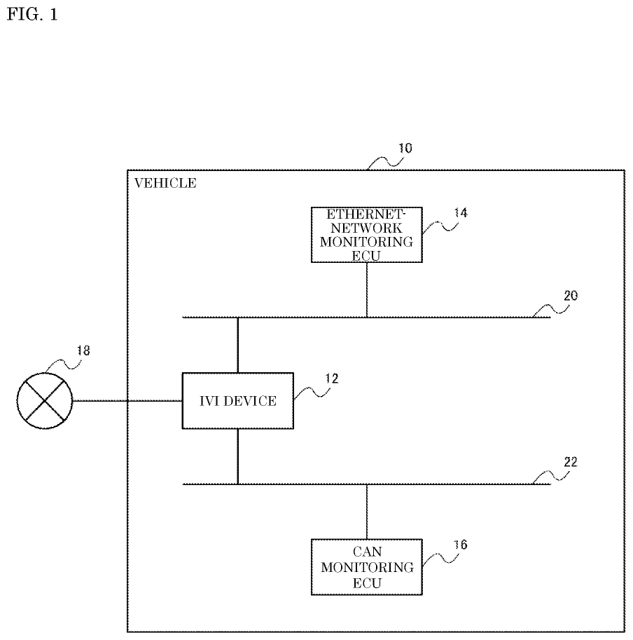

FIG. 1 schematically illustrates a configuration of vehicle 10 according to the exemplary embodiment. Vehicle 10 includes a network in vehicle 10 (hereinafter referred to as a “NW-in-vehicle”). The NW-in-vehicle includes Ethernet network 20 and controller area network (CAN) 22. Vehicle 10 also includes a plurality of kinds of monitoring devices that are in-vehicle infotainment (IVI) device 12, Ethernet-network monitoring electronic control unit (ECU) 14, and CAN monitoring ECU 16. The monitoring devices monitor states of subjects that are related to vehicle 10 and have been predetermined. The subjects of the monitoring include elements within vehicle 10, and elements that are outside vehicle 10 and are connected with vehicle 10 (e.g. a NW-outside-vehicle).

IVI device 12 is an electronic device that supplies various information to a user. IVI device 12 may have a car-navigation function and an audio function, for example. IVI device 12 is connected with NW-outside-vehicle 18, such as the Internet, to communicate with devices outside vehicle 10. IVI device 12 detects whether or not NW-outside-vehicle 18 is in an abnormal state. For example, IVI device 12 receives a message transmitted through NW-outside-vehicle 18, and detects whether or not the message is abnormal.

Ethernet-network monitoring ECU 14 includes an interface between Ethernet-network monitoring ECU 14 and Ethernet network 20. Ethernet-network monitoring ECU 14 monitors Ethernet network 20, and detects whether or not Ethernet network 20 is in an abnormal state. More specifically, if an Ethernet frame that is a message transmitted through Ethernet network 20 is abnormal, Ethernet-network monitoring ECU 14 detects Ethernet network 20 that is in an abnormal state. Ethernet-network monitoring ECU 14 may be a relay that is in Ethernet network 20 and has a monitoring function.

CAN monitoring ECU 16 includes an interface between CAN monitoring ECU 16 and CAN 22. CAN monitoring ECU 16 monitors CAN 22, and detects whether or not CAN 22 is in an abnormal state. More specifically, if a CAN frame that is a message transmitted through CAN 22 is abnormal, CAN monitoring ECU 16 detects CAN 22 that is in an abnormal state. CAN monitoring ECU 16 may be a relay that is in CAN 22 and has a monitoring function.

IVI device 12 is connected with Ethernet-network monitoring ECU 14 through Ethernet network 20. IVI device 12 is connected with CAN monitoring ECU 16 through CAN 22. Further, IVI device 12 or a predetermined GW (not illustrated) connects Ethernet-network monitoring ECU 14 with CAN monitoring ECU 16. Each of the messages may contain a command given to other device(s).

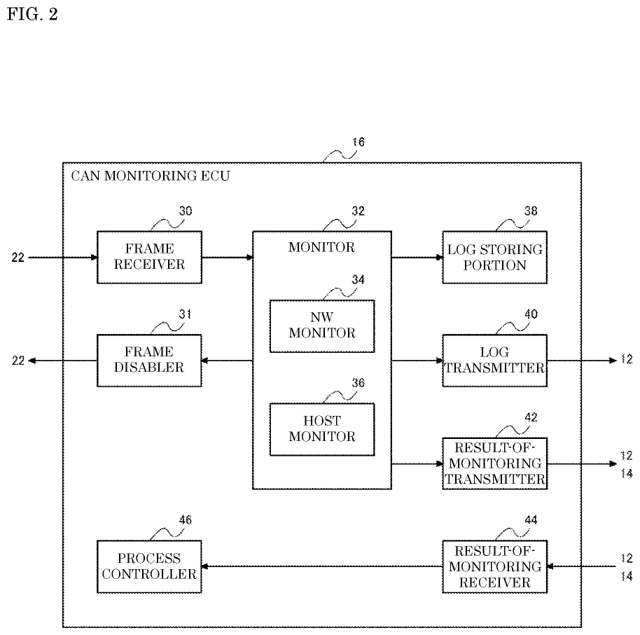

FIG. 2 is a block diagram that illustrates a functional configuration of CAN monitoring ECU 16 in FIG. 1. CAN monitoring ECU 16 includes frame receiver 30, frame disabler 31, monitor 32, log storing portion 38, log transmitter 40, result-of-monitoring transmitter 42, result-of-monitoring receiver 44, and process controller 46.

In the block diagram in the description, hardware part of each of blocks may be elements of a computer, such as a central processing unit (CPU) and a memory, and mechanical devices. Further, software part of each of the blocks may be a computer program. In the block diagram, however, each of the blocks illustrated is a functional block that includes the hardware part and the software part that cooperate with each other. It will be understood by those skilled in the art that each of the functional blocks may be in various forms that each include a combination of the hardware and the software.

A computer program that contains modules that correspond to the blocks in FIG. 2 may be stored in a recording medium. The computer program may be loaded into CAN monitoring ECU 16 from the recording medium. The computer program may be loaded into CAN monitoring ECU 16 through the networks. A CPU of CAN monitoring ECU 16 may perform functions of each of the blocks by appropriately reading and executing the computer program.

Monitor 32 monitors states of objects to be monitored that are related to vehicle 10 and have been predetermined. Monitor 32 is also referred to as an abnormality detector, and detects whether or not each of the objects to be monitored is in an abnormal state. Monitor 32 includes NW monitor 34 and host monitor 36.

Frame receiver 30 receives CAN frames that devices outside CAN monitoring ECU 16 (e.g. other ECUs, such as a brake ECU) output into CAN 22. NW monitor 34 detects whether or not a CAN frame received by frame receiver 30 (hereinafter also referred to as a “received frame”) is abnormal. For example, NW monitor 34 may store a black list that shows CAN-Identifiers (CAN-IDs) that should be disabled. If a CAN-ID assigned to a received frame corresponds to one of the CAN-IDs stored in the black list, NW monitor 34 may detect an abnormality in the received frame. Alternatively, NW monitor 34 may store a white list that shows legitimate CAN-IDs. NW monitor 34 may detect an abnormality in a received frame to which a CAN-ID that does not correspond to the white list is assigned. If a received frame is an Ethernet frame, NW monitor 34 determines whether the received frame is normal or abnormal, based on a media access control (MAC) address assigned to the received frame.

Alternatively, NW monitor 34 determines whether or not a received frame is abnormal, based on a cycle of messages (e.g. an interval between receptions of messages that each have a same CAN-ID). Alternatively, NW monitor 34 determines whether or not a received frame is abnormal, based on a characteristic of variation of data shown in a message. For example, NW monitor 34 determines that a received frame is abnormal, if an amount of variation of speed data shown in messages that each have a same CAN-ID exceeds a predetermined threshold.

If NW monitor 34 determines that a received frame is abnormal, frame disabler 31 performs a process that disables the received frame. For example, frame disabler 31 may disable a received frame that is being transmitted through CAN 22 by outputting, into CAN 22, an error frame that corresponds to the received frame. An error frame does not disable a received frame transmitted through some NWs (e.g. an Ethernet network). If an object to be monitored is such a NW, frame disabler 31 may filter (removes) a received frame in which an abnormality is detected, or may not allow a relay process to output the received frame into the NW again.

Host monitor 36 uses a publicly known technology, such as a digital signature, to detect an abnormality in CAN monitoring ECU 16. More specifically, host monitor 36 verifies whether or not legitimate firmware is stored in CAN monitoring ECU 16. In other words, host monitor 36 detects whether or not firmware of CAN monitoring ECU 16 has been tampered. Host monitor 36 performs what is called secure boot. That is to say, when CAN monitoring ECU 16 is enabled, host monitor 36 verifies whether or not firmware has been tampered. Further, when (or just before) an application runs in CAN monitoring ECU 16, host monitor 36 may verify whether or not the application has been tampered.

Further, if host monitor 36 detects an operation that is not in accordance with mandatory access control that is a function by which an operating system, such as Kernel, constrains particular processes and access to particular files, host monitor 36 determines that CAN monitoring ECU 16 is abnormal. For example, if firmware or an application accesses to a particular file to which the firmware and the application are not allowed to access by mandatory access control that has been predetermined, host monitor 36 may determine that CAN monitoring ECU 16 or firmware of CAN monitoring ECU 16 is abnormal.

Log storing portion 38 stores a monitoring log in a predetermined storage area. The monitoring log shows a result of monitoring performed by monitor 32 (in other words, a result of detection of an abnormality). For example, log storing portion 38 may store a monitoring log in nonvolatile memory within CAN monitoring ECU 16. The monitoring log shows that NW monitor 34 detects CAN 22 (or a frame transmitted through CAN 22) that is normal, or shows that NW monitor 34 detects CAN 22 (or a frame transmitted through CAN 22) that is abnormal. Further, log storing portion 38 may store a monitoring log in nonvolatile memory within CAN monitoring ECU 16. The monitoring log shows that host monitor 36 detects CAN monitoring ECU 16 (or firmware of CAN monitoring ECU 16) that is normal, or shows that host monitor 36 detects CAN monitoring ECU 16 (or firmware of CAN monitoring ECU 16) that is abnormal.

Log transmitter 40 transmits, to devices outside CAN monitoring ECU 16, a monitoring log that shows a result of monitoring performed by monitor 32. For example, log transmitter 40 may transmit, to entry-point devices (e.g. IVI device 12, and a TCU) that have been predetermined, monitoring logs each of which shows that NW monitor 34 detects CAN 22 that is normal, or shows that NW monitor 34 detects CAN 22 that is abnormal. The entry-point devices (e.g. IVI device 12, and a TCU) may store the monitoring logs. Further, log transmitter 40 may transmit, to the entry-point devices, monitoring logs each of which shows that host monitor 36 detects CAN monitoring ECU 16 that is normal, or shows that host monitor 36 detects CAN monitoring ECU 16 that is abnormal.

Result-of-monitoring transmitter 42 transmits a result of monitoring performed by monitor 32 to the other monitoring devices (IVI device 12, and Ethernet-network monitoring ECU 14 in the exemplary embodiment). The result of monitoring contains data that shows that NW monitor 34 detects CAN 22 that is normal, or shows that NW monitor 34 detects CAN 22 that is abnormal. Further, the result of monitoring contains data that shows that host monitor 36 detects CAN monitoring ECU 16 that is normal, or shows that host monitor 36 detects CAN monitoring ECU 16 that is abnormal.

Result-of-monitoring receiver 44 receives a result of detection of an abnormality transmitted from each of the other monitoring devices. For example, result-of-monitoring receiver 44 receives, from IVI device 12, a result of monitoring of NW-outside-vehicle 18 and a result of host monitoring. Further, result-of-monitoring receiver 44 receives, from Ethernet-network monitoring ECU 14, a result of monitoring of Ethernet frames, and a result of host monitoring.

Based on the results of detection of abnormalities detected by the other monitoring devices, process controller 46 changes a process that are related to security and are performed by CAN monitoring ECU 16, or switches between behaviors of vehicle 10. As described below, process controller 46 changes various types of operations. Following Examples 1 to 4 of operations-to-be-changed are processes that are related to security and are performed by CAN monitoring ECU 16.

### Example 1 of Operations-to-be-Changed: Form of Monitoring

Process controller 46 may switch between forms of operations of monitor 32. For example, process controller 46 may switch between processes used to detect whether or not CAN monitoring ECU 16 or CAN 22 is in an abnormal state. More specifically, process controller 46 may switch between monitor rules of monitor 32. For example, process controller 46 may switch between a rule under which an allowable range that is considered normal is wide and a rule under which an allowable range is narrow.

For example, a rule of NW monitoring under which an allowable range is wide may be a rule under which a relatively wide range of an amount of variation of a cycle or data is considered normal. For example, a rule of NW monitoring under which an allowable range is narrow may be a rule under which a relatively narrow range of an amount of variation of a cycle or data is considered normal. Further, for example, a rule of host monitoring under which an allowable range is wide may be a rule under which a relatively small number of pieces of program or a relatively small number of kinds of program are subjects to be detected that are used to detect at least one of tampering and violation of mandatory access control. For example, a rule of host monitoring under which an allowable range is narrow may be a rule under which a relatively large number of pieces of program or a relatively large number of kinds of program are subjects to be detected that are used to detect at least one of tampering and violation of mandatory access control.

Further, process controller 46 may expand or reduce a range monitored by monitor 32. For example, process controller 46 may allow monitor 32 to detect tampering to middleware. Alternatively process controller 46 may allow monitor 32 to detect tampering to middleware and tampering to each of applications. Further, process controller 46 may switch between timings at which monitor 32 monitors. For example, process controller 46 may allow monitor 32 to verify, only at a time of start of software, whether or not the software has been tampered. Alternatively, process controller 46 may allow monitor 32 to verify periodically whether or not a plurality of pieces of software have been tampered.

### Example 2 of Operations-to-be-Changed: Form of Disabling of Command

Process controller 46 may switch between forms of operations of frame disabler 31. More specifically, a CAN frame in which an abnormality is detected may be disabled with an error frame. Alternatively, a CAN frame in which an abnormality is detected may not be disabled, but may be recorded. Further, process controller 46 may or may not allow frame disabler 31 to filter (for example, remove) a message (e.g. a CAN frame or an Ethernet frame) in which an abnormality is detected.

### Example 3 of Operations-to-be-Changed: Form of Recording of Abnormality

Process controller 46 may switch between forms of operations of log storing portion 38. More specifically, process controller 46 may or may not allow log storing portion 38 to store monitoring logs in nonvolatile memory. Further, process controller 46 may switch between subjects stored in a monitoring log. For example, process controller 46 may allow log storing portion 38 to store only a message in which an abnormality is detected. Alternatively, process controller 46 may allow log storing portion 38 to store a message in which an abnormality is detected, and a predetermined number of messages before the message in which an abnormality is detected, and a predetermined number of messages after the message in which an abnormality is detected. The latter form is useful for grasping a sign of an occurrence of an abnormality or a trend in an occurrence of an abnormality.

### Example 4 of Operations-to-be-Changed: Form of Notification of Abnormality

Process controller 46 may switch between forms of operations of log transmitter 40. More specifically, process controller 46 may or may not allow log transmitter 40 to transmit monitoring logs to a security operation center (SOC, not illustrated) outside vehicle 10. Further, process controller 46 may or may not allow log transmitter 40 to transmit monitoring logs to the other monitoring devices (IVI device 12, TCU).

Example 5 of Operations-to-be-changed: Form of Operation of Vehicle Process controller 46 may switch between a state in which an autonomous-driving function of vehicle 10 is enabled and a state in which the autonomous-driving function of vehicle 10 is disabled. In that case, process controller 46 may transmit a command to an autonomous-driving controller (not illustrated) or an advanced driver assistance system (ADAS) ECU (not illustrated) of vehicle 10 to enable the autonomous-driving function (in other words, start the autonomous-driving function). Alternatively, process controller 46 may transmit a command to an autonomous-driving controller (not illustrated) or an advanced driver assistance system (ADAS) ECU (not illustrated) of vehicle 10 to disabled the autonomous-driving function (in other words, terminate the autonomous-driving function). Further, process controller 46 may cooperate with the autonomous-driving controller, the ADAS, or other ECU(s) to switch between a state in which a fail-safe process (e.g. a process that terminates autonomous driving) is enabled in vehicle 10 and a state in which the fail-safe process is disabled in vehicle 10.

A functional configuration of IVI device 12 is similar to the functional configuration of CAN monitoring ECU 16 (FIG. 2). A difference is that frame receiver 30 of IVI device 12 receives communication frames from NW-outside-vehicle 18. Further, result-of-monitoring transmitter 42 of IVI device 12 transmits results of monitoring to Ethernet-network monitoring ECU 14 and CAN monitoring ECU 16. Further, result-of-monitoring receiver 44 of WI device 12 receives results of monitoring from Ethernet-network monitoring ECU 14 and CAN monitoring ECU 16. Further, frame disabler 31 of IVI device 12 may filter (for example, remove) a received frame instead of transmitting an error frame, based on an address of the received frame, a cycle of the received frame, or a characteristic of variation of data of the received frame.

A functional configuration of Ethernet-network monitoring ECU 14 is similar to the functional configuration of CAN monitoring ECU 16 (FIG. 2). A difference is that frame receiver 30 of Ethernet-network monitoring ECU 14 receives frames from Ethernet network 20. Further, result-of-monitoring transmitter 42 of Ethernet-network monitoring ECU 14 transmits results of monitoring to IVI device 12 and CAN monitoring ECU 16. Further, result-of-monitoring receiver 44 of Ethernet-network monitoring ECU 14 receives results of monitoring from IVI device 12 and CAN monitoring ECU 16. Further, frame disabler 31 of Ethernet-network monitoring ECU 14 may filter (for example, remove) a received frame instead of transmitting an error frame, based on an address of the received frame, a cycle of the received frame, or a characteristic of variation of data of the received frame.

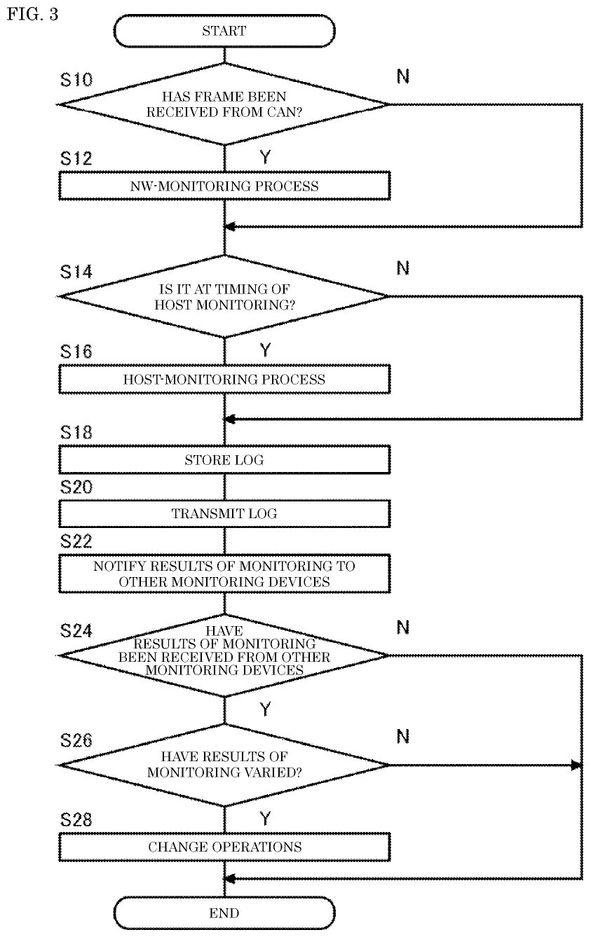

FIG. 3 is a flowchart that illustrates operations of CAN monitoring ECU 16 in FIG. 1. FIG. 3 mainly illustrates monitoring processes and processes related to security, among processes performed by CAN monitoring ECU 16. The other monitoring devices of vehicle 10, that is to say IVI device 12 and Ethernet-network monitoring ECU 14 each perform monitoring processes and processes related to security that are similar to monitoring processes and processes related to security that are performed by CAN monitoring ECU 16.

If frame receiver 30 receives a CAN frame from CAN 22 (Y in S10), NW monitor 34 determines whether or not the CAN frame that frame receiver 30 has received is normal (S12). If a CAN frame has not been received (N in S10), S12 is skipped. At a timing of host monitoring (for example, at a time at which CAN monitoring ECU 16 is enabled, or at a time at which a predetermined period of time has passed from a previous host monitoring) (Y in S14), host monitor 36 verifies whether or not firmware stored in memory of CAN monitoring ECU 16 is normal (S16). If it is not at a timing of host monitoring (N in S14), S16 is skipped. NW monitoring and host monitoring are performed in any order. Further, NW monitoring and host monitoring may be performed simultaneously.

In response to at least one of a result of host monitoring and a result of NW monitoring, log storing portion 38 stores, in a predetermined storage area, a log that shows the result of host monitoring and the result of NW monitoring (S18). In response to at least one of a result of host monitoring and a result of NW monitoring, log transmitter 40 transmits, to predetermined devices outside CAN monitoring ECU 16, a log that shows the result of host monitoring and the result of NW monitoring (S20). Result-of-monitoring transmitter 42 transmits, to IVI device 12 and Ethernet-network monitoring ECU 14, both data that shows a result of host monitoring and data that shows a result of NW monitoring (S22). Due to a timing of host monitoring and a timing of NW monitoring, a result of the host monitoring or a result of the NW monitoring may be transmitted. Alternatively, result-of-monitoring transmitter 42 may transmit results of monitoring to IVI device 12 or Ethernet-network monitoring ECU 14.

IVI device 12 and Ethernet-network monitoring ECU 14 each output data that shows a result of host monitoring and data that shows a result of NW monitoring. Result-of-monitoring receiver 44 receives, through a communication network, the data that shows a result of host monitoring and the data that shows a result of NW monitoring (Y in S24). If at least one of the data that shows a result of host monitoring and the data that shows a result of NW monitoring varies from previous data that had been received (Y in S26), process controller 46 switches between processes that are related to security and have been predetermined, or switches between behaviors of vehicle 10 (S28). If result-of-monitoring receiver 44 has not received results of monitoring performed by the other monitoring devices (N in S24), S26 and S28 are skipped. If results of monitoring do not vary (N in S26), S28 is skipped. CAN monitoring ECU 16 repeats the processes illustrated in FIG. 3.

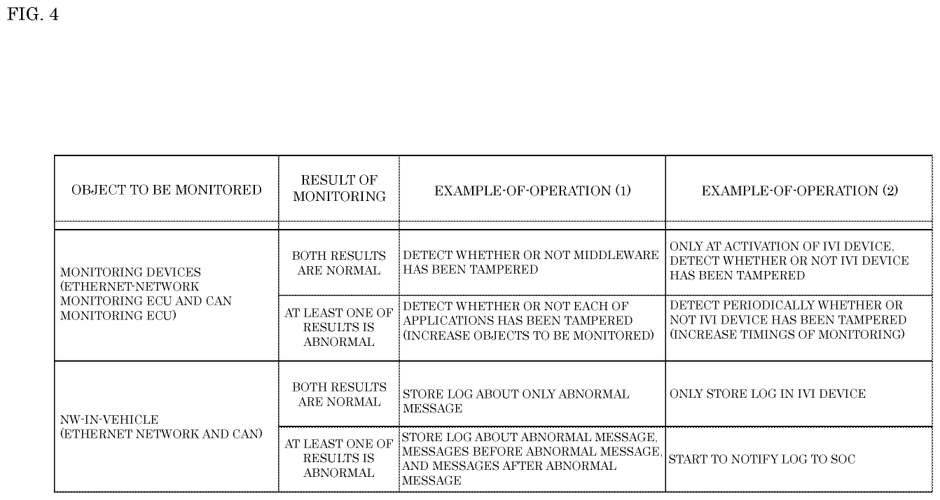

A specific example of switch between operations in S28 in FIG. 3 will be described. FIG. 4 illustrates an example of switch between operations of IVI device 12. IVI device 12 includes functional blocks that are similar to the functional blocks of CAN monitoring ECU 16 (FIG. 2). In Example-of-operation (1), if results of host monitoring performed by a plurality of the other monitoring devices are normal, process controller 46 allows host monitor 36 to detect whether or not middleware has been tampered, in host monitoring of IVI device 12. On the other hand, if at least one of results of host monitoring performed by a plurality of the other monitoring devices is abnormal, process controller 46 allows host monitor 36 to detect whether or not middleware and each of applications have been tampered, in host monitoring of IVI device 12.

Further, if results of NW monitoring performed by a plurality of the other monitoring devices are normal, process controller 46 allows log storing portion 38 to store, in nonvolatile memory, only a message in which an abnormality is detected, in NW monitoring of IVI device 12. On the other hand, if at least one of results of NW monitoring performed by a plurality of the other monitoring devices is abnormal, process controller 46 allows log storing portion 38 to store, in nonvolatile memory, a message in which an abnormality is detected, and a predetermined number of messages before the message in which an abnormality is detected, and a predetermined number of messages after the message in which an abnormality is detected, in NW monitoring of IVI device 12.

In Example-of-operation (2), if results of host monitoring performed by a plurality of the other monitoring devices are normal, process controller 46 allows host monitor 36 to detect, only at a time of activation of IVI device 12, whether or not firmware has been tampered, in host monitoring of IVI device 12. On the other hand, if at least one of results of host monitoring performed by a plurality of the other monitoring devices is abnormal, process controller 46 allows host monitor 36 to detect periodically whether or not firmware has been tampered, as host monitoring of IVI device 12.

Further, if results of NW monitoring performed by a plurality of the other monitoring devices are normal, process controller 46 allows log storing portion 38 to store, in a local storage area, a monitoring log about IVI device 12, and does not allow log transmitter 40 to transmit the monitoring log about WI device 12 to devices outside IVI device 12. On the other hand, if at least one of results of NW monitoring performed by a plurality of the other monitoring devices is abnormal, process controller 46 allows log storing portion 38 to store, in a local storage area, a monitoring log about IVI device 12, and allows log transmitter 40 to transmit the monitoring log about IVI device 12 to the SOC.

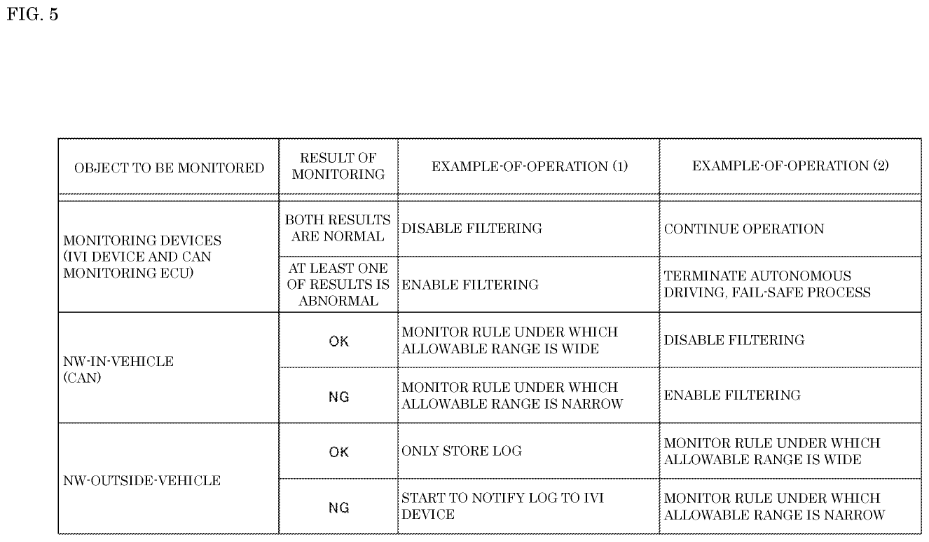

FIG. 5 illustrates an example of switch between operations of Ethernet-network monitoring ECU 14. Ethernet-network monitoring ECU 14 includes functional blocks that are similar to the functional blocks of CAN monitoring ECU 16 (FIG. 2). In Example-of-operation (1), if results of host monitoring performed by a plurality of the other monitoring devices are normal, process controller 46 does not allow frame disabler 31 to perform a filtering process, such as removal of a frame. On the other hand, if at least one of results of host monitoring performed by a plurality of the other monitoring devices is abnormal, process controller 46 allows frame disabler 31 to enable the filtering process.

Further, if a result of NW monitoring performed by CAN monitoring ECU 16 is normal, process controller 46 allows at least one of NW monitor 34 and host monitor 36 to perform a monitoring process based on a monitor rule under which an allowable range is relatively wide. In other words, process controller 46 relaxes a criterion used to determine whether or not Ethernet network 20 is normal. On the other hand, if a result of NW monitoring performed by CAN monitoring ECU 16 is abnormal, process controller 46 allows at least one of NW monitor 34 and host monitor 36 to perform a monitoring process based on a monitor rule under which an allowable range is relatively narrow. In other words, process controller 46 tightens the criterion used to determine whether or not Ethernet network 20 is normal.

Further, if a result of NW monitoring performed by IVI device 12 is normal, process controller 46 allows log storing portion 38 to store, in a local storage area, a monitoring log about Ethernet-network monitoring ECU 14, and does not allow log transmitter 40 to transmit the monitoring log about Ethernet-network monitoring ECU 14 to devices outside Ethernet-network monitoring ECU 14. On the other hand, if a result of NW monitoring performed by WI device 12 is abnormal, process controller 46 allows log storing portion 38 to store, in a local storage area, a monitoring log about Ethernet-network monitoring ECU 14, and allows log transmitter 40 to transmit the monitoring log about Ethernet-network monitoring ECU 14 to IVI device 12.

In Example-of-operation (2), if results of host monitoring performed by a plurality of the other monitoring devices are normal, process controller 46 does not switch between operations, and continues a monitoring operation that has been performed. On the other hand, if at least one of results of host monitoring performed by a plurality of the other monitoring devices is abnormal, process controller 46 allows the autonomous-driving controller or other ECU(s) to perform a fail-safe process. The fail-safe process includes at least one of transmitting, to the autonomous-driving controller, a command that terminates autonomous driving, and stopping vehicle 10.

If a result of NW monitoring performed by CAN monitoring ECU 16 is normal, process controller 46 does not allow frame disabler 31 to perform a filtering process, such as removal of a frame in which an abnormality is detected. On the other hand, if a result of NW monitoring performed by CAN monitoring ECU 16 is abnormal, process controller 46 allows frame disabler 31 to perform a filtering process.

Further, if a result of NW monitoring performed by IVI device 12 is normal, process controller 46 allows at least one of NW monitor 34 and host monitor 36 to perform a monitoring process based on a monitor rule under which an allowable range is relatively wide. On the other hand, if a result of NW monitoring performed by IVI device 12 is abnormal, process controller 46 allows at least one of NW monitor 34 and host monitor 36 to perform a monitoring process based on a monitor rule under which an allowable range is relatively narrow.

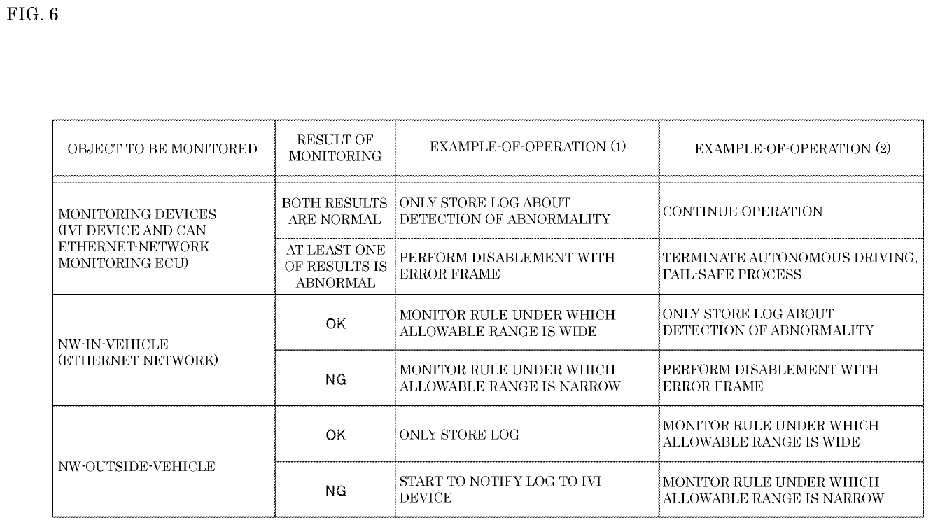

FIG. 6 illustrates an example of switch between operations of CAN monitoring ECU 16. In Example-of-operation (1), if results of host monitoring performed by a plurality of the other monitoring devices are normal, process controller 46 allows log storing portion 38 to store, in a predetermined storage area, a log about a frame in which an abnormality is detected, and does not allow frame disabler 31 to output an error frame that corresponds to the frame in which an abnormality is detected. On the other hand, if at least one of results of host monitoring performed by a plurality of the other monitoring devices is abnormal, process controller 46 allows log storing portion 38 to store, in a predetermined storage area, a log about a frame in which an abnormality is detected, and allows frame disabler 31 to output an error frame that corresponds to the frame in which an abnormality is detected.

Further, if a result of NW monitoring performed by Ethernet-network monitoring ECU 14 is normal, process controller 46 allows at least one of NW monitor 34 and host monitor 36 to perform a monitoring process based on a monitor rule under which an allowable range is relatively wide. On the other hand, if a result of NW monitoring performed by Ethernet-network monitoring ECU 14 is abnormal, process controller 46 allows at least one of NW monitor 34 and host monitor 36 to perform a monitoring process based on a monitor rule under which an allowable range is relatively narrow.

Further, if a result of NW monitoring performed by IVI device 12 is normal, process controller 46 allows log storing portion 38 to store, in a local storage area, a monitoring log about CAN monitoring ECU 16, and does not allow log transmitter 40 to transmit the monitoring log about CAN monitoring ECU 16 to devices outside CAN monitoring ECU 16. On the other hand, if a result of NW monitoring performed by IVI device 12 is abnormal, process controller 46 allows log storing portion 38 to store, in a local storage area, a monitoring log about CAN monitoring ECU 16, and allows log transmitter 40 to transmit the monitoring log about CAN monitoring ECU 16 to IVI device 12.

In Example-of-operation (2), if results of host monitoring performed by a plurality of the other monitoring devices are normal, process controller 46 does not switch between operations, and continues a monitoring operation that has been performed. On the other hand, if at least one of results of host monitoring performed by a plurality of the other monitoring devices is abnormal, process controller 46 allows the autonomous-driving controller or other ECU(s) to perform a fail-safe process. The fail-safe process includes at least one of transmitting, to the autonomous-driving controller, a command that terminates autonomous driving, and stopping vehicle 10.

Further, if a result of NW monitoring performed by Ethernet-network monitoring ECU 14 is normal, process controller 46 allows log storing portion 38 to store, in a predetermined storage area, a log about a frame in which an abnormality is detected, and does not allow frame disabler 31 to output an error frame that corresponds to the frame in which an abnormality is detected. On the other hand, if a result of NW monitoring performed by Ethernet-network monitoring ECU 14 is abnormal, process controller 46 allows log storing portion 38 to store, in a predetermined storage area, a log about a frame in which an abnormality is detected, and allows frame disabler 31 to output an error frame that corresponds to the frame in which an abnormality is detected.

Further, if a result of NW monitoring performed by IVI device 12 is normal, process controller 46 allows at least one of NW monitor 34 and host monitor 36 to perform a monitoring process based on a monitor rule under which an allowable range is relatively wide. On the other hand, if a result of NW monitoring performed by IVI device 12 is abnormal, process controller 46 allows at least one of NW monitor 34 and host monitor 36 to perform a monitoring process based on a monitor rule under which an allowable range is relatively narrow.

In the exemplary embodiment, the monitoring devices attached to vehicle 10 (e.g. IVI device 12, Ethernet-network monitoring ECU 14, and CAN monitoring ECU 16) cooperate with each other. Consequently, each of the monitoring devices grasps states of objects to be monitored that are not monitored by the monitoring device, and thus performs a process that is related to security and corresponds to states of whole vehicle 10. Further, behaviors of vehicle 10 are switched in such a manner that behavior of vehicle 10 corresponds to states of whole vehicle 10. Consequently, an excessive fail-safe process is not easily performed even if one of the monitoring devices wrongly detects an abnormality.

The present disclosure is described above according to the exemplary embodiment. It will be understood by those skilled in the art that the exemplary embodiment is merely an example. Further, in modifications of the exemplary embodiment, components or processes of the exemplary embodiment are variously combined. Further, the modifications fall within the scope of the present disclosure.

A first example of the modifications will be described. A plurality of kinds of forms of switch between operations are predetermined. Process controller 46 may select one of the plurality of kinds of forms of switch between operations, according to a number of abnormalities detected by a plurality of the other monitoring devices. The number of abnormalities detected by a plurality of the other monitoring devices may be a number of the monitoring devices that each detect an abnormality in a same object to be monitored (e.g. an inside of each of the monitoring devices, and the NW-in-vehicle), or may be a number of objects to be monitored in each of which an abnormality is detected. The larger the number of abnormalities detected by a plurality of the other monitoring devices, process controller 46 may switch to a stricter criterion used to monitor one of the monitoring device that includes process controller 46 in question, or may perform a process that is related to security and corresponds to a more serious abnormality.

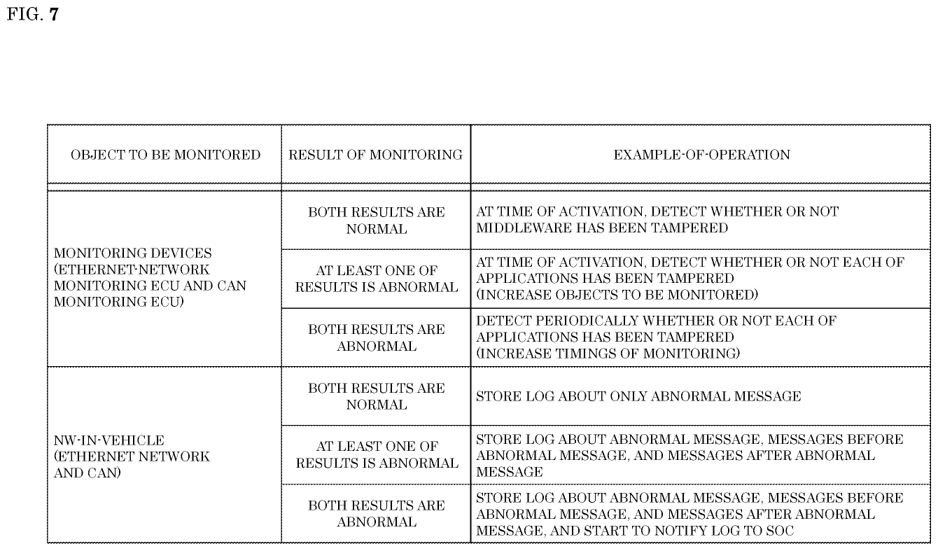

FIG. 7 illustrates an example of switch between operations of IVI device 12 in the first example of the modifications. If results of host monitoring performed by a plurality of the other monitoring devices are normal, process controller 46 allows host monitor 36 to detect, at a time of activation of IVI device 12, whether or not middleware has been tampered, in host monitoring of IVI device 12. On the other hand, if at least one of results of host monitoring performed by a plurality of the other monitoring devices is abnormal, process controller 46 allows host monitor 36 to detect, at a time of activation of IVI device 12, whether or not middleware and each of applications have been tampered, in host monitoring of IVI device 12.

Further, if results of host monitoring performed by a plurality of the other monitoring devices are abnormal, process controller 46 allows host monitor 36 to detect, at a time of activation of IVI device 12, whether or not each of applications has been tampered, and process controller 46 allows host monitor 36 to detect periodically whether or not each of the applications has been tampered. If results of host monitoring performed by a plurality of the other monitoring devices are abnormal, there is a strong possibility that IVI device 12 receives an attack, such as tampering to program. Accordingly, process controller 46 increases objects to be monitored and timings of monitoring, compared with a usual monitoring. Therefore, an abnormality in IVI device 12 is easily, quickly and surely detected.

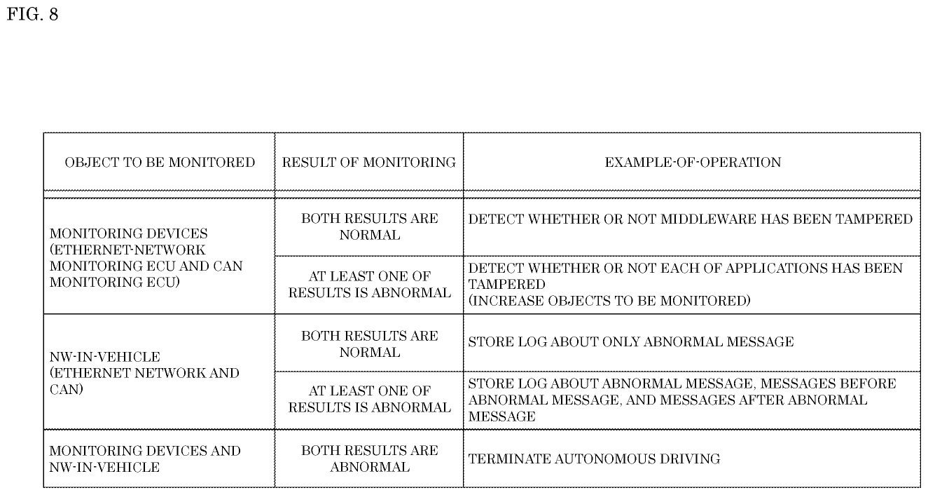

A second example of the modifications will be described. There are a plurality of kinds of objects to be monitored. According to a number of (a number of kinds of) the objects to be monitored in which an abnormality is detected by a plurality of the other monitoring devices, process controller 46 may select one of a plurality of kinds of forms of switch between operations. FIG. 8 illustrates an example of switch between operations of IVI device 12 in the second example of the modifications. First to fourth rows in FIG. 8 each shows switch between operations based on a result of host monitoring or NW monitoring. The switch between operations based on a result of host monitoring or NW monitoring has been described in Example-of-operation (1) in FIG. 4, and will not be described again.

Based on a result of host monitoring or a result of NW monitoring, process controller 46 performs switch between operations described above. Further, if both a result of host monitoring and a result of NW monitoring are abnormal, process controller 46 terminates autonomous driving of vehicle 10. If both a result of host monitoring and a result of NW monitoring are abnormal, process controller 46 may increase objects to be monitored, may increase subject to be stored in a log, and may terminate autonomous driving. Further, if at least one of a result of host monitoring performed by Ethernet-network monitoring ECU 14 and a result of host monitoring performed by CAN monitoring ECU 16 is abnormal, and if at least one of a result of NW monitoring performed by Ethernet-network monitoring ECU 14 and a result of NW monitoring performed by CAN monitoring ECU 16 is abnormal, process controller 46 may determine that both host monitoring and NW monitoring are abnormal.

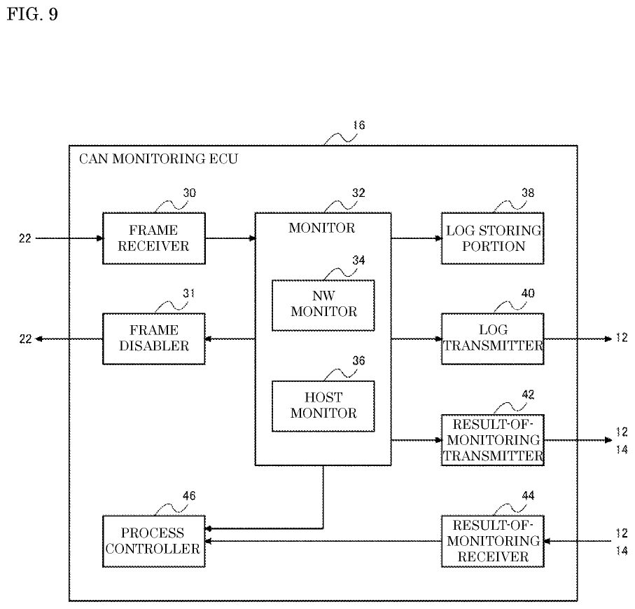

A third example of the modifications will be described. FIG. 9 corresponds to FIG. 2, and is a block diagram that illustrates a functional configuration of CAN monitoring ECU 16 in the third example of the modifications. A functional configuration of IVI device 12 and a functional configuration of Ethernet-network monitoring ECU 14 are similar to a functional configuration of CAN monitoring ECU 16. Monitor 32 may also output, to process controller 46, both a result of NW monitoring performed by NW monitor 34 and a result of host monitoring performed by host monitor 36. Based on a combination of results of monitoring performed by the other monitoring devices, and the results of monitoring performed by CAN monitoring ECU 16, process controller 46 may switch between processes that are related to security and are performed by CAN monitoring ECU 16, or may switch between behaviors of vehicle 10.

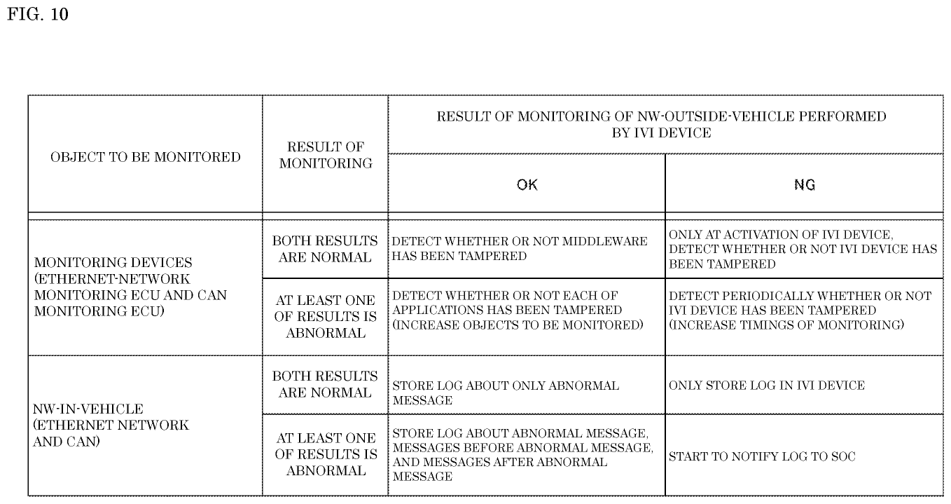

FIG. 10 illustrates an example of switch between operations of IVI device 12 in the third example of the modifications. Operations in FIG. 10 have been described with reference to FIG. 4, and will not be described again. If results of host monitoring performed by the other monitoring devices are abnormal, and if a result of monitoring of the NW-outside-vehicle performed by IVI device 12 is abnormal, there may be a major risk to security. Therefore, process controller 46 controls host monitoring of IVI device 12 to detect whether or not each of applications has been tampered, and to periodically detect whether or not IVI device 12 has been tampered. Similarly, If results of monitoring of the NW-in-vehicle performed by the other monitoring devices are abnormal, and if a result of monitoring of the NW-outside-vehicle performed by IVI device 12 is abnormal, process controller 46 allows an abnormal message, and messages before the abnormal message, and messages after the abnormal message to be stored in a log, and starts to allow the log to be notified to the SOC.

A fourth example of the modifications will be described. A degree of importance may be preliminarily assigned to each of objects to be monitored. Process controller 46 of each of the monitoring devices may switch operations, according to a degree of importance assigned to an object to be monitored in which an abnormality has been detected. More specifically, a plurality of kinds of forms of switch between operations are predetermined. Process controller 46 may select one of the plurality of kinds of forms of switch between operations, according to a degree of importance of an object to be monitored in which an abnormality has been detected by a plurality of the other monitoring devices. The degree of importance may be assigned according to types of objects to be monitored (an inside of each of the monitoring devices, the NW-in-vehicle, and the NW-outside-vehicle). For example, a low degree of importance may be assigned to the NW-outside-vehicle. An intermediate degree of importance may be assigned to the NW-in-vehicle. A high degree of importance may be assigned to an inside of each of the monitoring devices. Further, the degree of importance may be assigned according to a number of objects to be monitored in each of which an abnormality has been detected. The larger the number, the higher degree of importance may be assigned. Further, different degrees of importance may be assigned to same kinds of objects to be monitored (e.g. a CAN, and an Ethernet network), respectively. The higher a degree of importance of an object to be monitored in which an abnormality has been detected, process controller 46 may switch to a stricter criterion used to monitor one of the monitoring devices that includes process controller 46 in question, or may perform a process that is related to security and corresponds to a more serious abnormality.

Another example of the modifications will be described. Vehicle 10 may include other monitoring device(s) that is/are not described in the exemplary embodiment. A number of the monitoring devices is not limited. For example, vehicle 10 may include NWs that are not described in the exemplary embodiment, such as a CAN with flexible data-rate (CAN FD), FlexRay, and Media Oriented Systems Transport (MOST). Further, vehicle 10 may include monitoring devices that monitor the NWs. Further, if same kinds of NWs include a plurality of channels (e.g. a plurality of buses), a monitoring device may be provided for each of the channels. For example, two monitoring devices that each monitor an entry point may be provided for two kinds of NWs-outside-vehicle, respectively. Further, two CAN monitoring ECUs may be provided for two CANs, respectively.

Two monitoring devices may be attached to vehicle 10. In a description below, IVI device 12 and CAN monitoring ECU 16 are attached to vehicle 10. An example of switch between operations of IVI device 12 will be described with reference to Example-of-operation (1) in FIG. 4. If a result of host monitoring performed by CAN monitoring ECU 16 is normal, IVI device 12 allows detection of whether or not middleware has been tampered, in host monitoring of WI device 12. On the other hand, if a result of host monitoring performed by CAN monitoring ECU 16 is abnormal, IVI device 12 allows detection of whether or not middleware and each of applications have been tampered, in host monitoring of IVI device 12. Further, if a result of NW monitoring performed by CAN monitoring ECU 16 is normal, IVI device 12 allows only a message in which an abnormality has been detected to be stored in nonvolatile memory, in NW monitoring of IVI device 12. On the other hand, if a result of NW monitoring performed by CAN monitoring ECU 16 is abnormal, IVI device 12 allows a message in which an abnormality has been detected, and a predetermined number of messages before the message in which an abnormality has been detected, and a predetermined number of messages after the message in which an abnormality has been detected to be stored in nonvolatile memory, in NW monitoring of IVI device 12.

A gateway and any ECU, such as a control ECU, may have a monitoring function described in the exemplary embodiment.

Any publicly known technology may be applied to a method by which the monitoring devices notify data of a result of monitoring to each other. For example, a result of monitoring may be notified through a network in a vehicle (e.g. a CAN, a CAN FD, an Ethernet network, MOST, and FlexRay). Alternatively, a result of monitoring may be notified through a special line (e.g. cables, a CAN, and an Ethernet network).

Process controller 46 not only transmits a command that switches between activation and deactivation of autonomous driving, but also may transmit, to other devices, a command that switches between operations, according to a result of monitoring.

A result of monitoring not only shows an abnormality or a normalcy, but also may show a pending state. The pending state may include a state in which a monitoring function has not been operated. Further, the pending state may include a state in which a monitoring function is performing verification. The plurality of monitoring devices of vehicle 10 may notify, to each other, a result of monitoring that shows a pending state, when a monitoring function has not been operated or when the monitoring device is performing verification.

If a result of monitoring is a pending state, process controller 46 may perform a process that is different from a process performed when a result of monitoring is normal and abnormal. If at least one of all results of monitoring, e.g. results of host monitoring performed by one of the monitoring devices and the other monitoring devices and results of NW monitoring performed by the one of the monitoring devices and the other monitoring devices includes a pending state or an abnormality, process controller 46 of the one of the monitoring devices does not allow the autonomous-driving controller or the ADAS to enable an autonomous-driving function. Further, if one of the other monitoring devices notifies, to process controller 46, a result of monitoring that shows a pending state, process controller 46 does not allow frame disabler 31 to perform a process that disables frames, until the monitoring device that has notified, to process controller 46, a result of monitoring that shows a pending state notifies a result of monitoring that shows an abnormality, that is to say, until an abnormality is determined.

Further, a result of monitoring not only shows an abnormality and a normalcy, but also may show an intermediate state. Alternatively, a result of monitoring not only shows an abnormality, a normalcy, and a pending state, but also may show an intermediate state. It is difficult for the monitoring function to determine whether the intermediate state is a normalcy or an abnormality. For example, if a message has a value that is within a normal range, but the value of the message is close to a threshold based on which an abnormality is determined, NW monitor 34 may determine that the message is in an intermediate state, or may determine that a result of NW monitoring is in an intermediate state. Similarly, if a value related to a state of one of the monitoring devices is within a normal range, but the value is close to a threshold based on which an abnormality is determined, host monitor 36 of the one of the monitoring devices may determine that a result of host monitoring is in an intermediate state. If a result of monitoring is an intermediate state, process controller 46 may perform a process that is different from a process performed when a result of monitoring is normal, abnormal, or a pending state.

In the exemplary embodiment, the present disclosure is described as security measures in a network in a vehicle. However, the present disclosure is not only applicable to security measures in a network in a vehicle. Vehicles are an example of mobility. The present disclosure is not only applicable to vehicles, but also applicable to mobility, such as construction machinery, agricultural machinery, vessels, railroads, and airplanes.

Technologies disclosed in the exemplary embodiment and the examples of the modifications of the exemplary embodiment may be identified by the following items.

### [Item 1]

A monitoring device is one of a plurality of monitoring devices to be attached to mobility. The monitoring device is configured to monitor an abnormal state of a first object to be monitored. The monitoring device includes a receiver and a controller. The receiver is configured to receive a result of detection of an abnormality detected by another monitoring device that monitors an abnormal state of a second object to be monitored that is different from the first object to be monitored. The controller is configured to change a process to be performed by the monitoring device, according to the result of detection of the abnormality detected by the other monitoring device.

The monitoring device more appropriately controls forms of processes related to security or behaviors of the mobility, according to states of various components related to the mobility that are not monitored by the monitoring device itself.

### [Item 2]

The monitoring device described in Item 1 may be an entry-point device. The first object to be monitored may be an entry-point device or a network outside the mobility. The other monitoring device may be an electronic control unit. The second object to be monitored may be an electronic control unit or a network in the mobility.

The monitoring device more appropriately controls forms of processes related to security or behaviors of the mobility, according to states of various components related to the mobility that are not monitored by the monitoring device itself.

### [Item 3]

The monitoring device described in Item 2 may further include a detector configured to detect whether or not the first object to be monitored is in an abnormal state. The controller may change a detection process to be performed by the detector.

The monitoring device appropriately adjusts a form of a monitoring process, according to states of various components related to the mobility.

### [Item 4]

The monitoring device described in Item 2 or 3 may further include a storing portion configured to store a log that shows a result of detection of an abnormality of the first object to be monitored. The controller may change a storage process to be performed by the storing portion.

The monitoring device appropriately adjusts a form of a storage process of the log, according to states of various components related to the mobility.

### [Item 5]

The monitoring device described in Item 1 may be a first monitoring electronic control unit that monitors a first network in the mobility. The first object to be monitored may be the first monitoring electronic control unit or the first network. The other monitoring device may be a second monitoring electronic control unit that monitors a second network that is different from the first network and is in the mobility. The second object to be monitored may be the second monitoring electronic control unit or the second network.

The monitoring device more appropriately controls forms of processes related to security or behaviors of the mobility, according to states of various components related to the mobility that are not monitored by the monitoring device itself.

### [Item 6]

In the monitoring device described in Item 5, one of the first network and the second network may be an Ethernet network, and the other one may be a controller area network (CAN).

The monitoring device more appropriately controls forms of processes related to security or behaviors of the mobility, according to states of the Ethernet network and the CAN that are in the mobility.

### [Item 7]

The monitoring device described in Item 5 or 6 may further include a detector configured to detect whether or not the first object to be monitored is in an abnormal state. The controller may change a detection process to be performed by the detector.

The monitoring device more appropriately controls monitoring processes performed by the monitoring device, according to states of various components related to the mobility that are not monitored by the monitoring device itself.

### [Item 8]

The monitoring device described in any one of Items 5 to 7 may further include a frame receiver and a disabler. The frame receiver is configured to receive a message transmitted from a device outside the monitoring device. A disabler is configured to disable the message. The controller may change a disablement process to be performed by the disabler.

The monitoring device appropriately adjusts a form of filtering of messages or a form of disablement, according to states of various components related to the mobility.

### [Item 9]

The monitoring device described in any one of Items 5 to 8 may further include a storing portion configured to store a log that shows a result of detection of an abnormality of the first object to be monitored. The controller may change a storage process to be performed by the storing portion.

The monitoring device appropriately adjusts a form of a storage process of the log, according to states of various components related to the mobility.

### [Item 10]

The monitoring device described in any one Items 5 to 9 may further include a notifying portion configured to notify, to a device outside the monitoring device, a log that shows a result of detection of an abnormality of the first object to be monitored. The controller may change a notification process to be performed by the notifying portion.

The monitoring device appropriately adjusts a form of a notification process of the log, according to states of various components related to the mobility.

### [Item 11]

In the monitoring device described in any one of Items 5 to 10, the controller may change a process related to an autonomous-driving function of the mobility.

The monitoring device appropriately controls the autonomous-driving function of the mobility, according to states of various components related to the mobility.

### [Item 12]

A monitoring system includes a first monitoring device and a second monitoring device. The first monitoring device is to be attached to mobility. The first monitoring device is configured to detect whether or not a first object to be monitored is in an abnormal state, and is configured to transmit, to the second monitoring device that monitors a second object to be monitored that is different from the first object to be monitored, a result of detection of an abnormality. The second monitoring device is to be attached to the mobility. The second monitoring device is configured to receive the result of detection of the abnormality transmitted from the first monitoring device, and is configured to change a process to be performed by the second monitoring device, according to the result of detection of the abnormality.

The monitoring system more appropriately controls forms of processes related to security or behaviors of the mobility, according to states of various components related to the mobility that are not monitored by one of the monitoring devices.

### [Item 13]

A computer program causes a monitoring device to execute a method. The monitoring device is one of a plurality of monitoring devices attached to mobility. The monitoring device is configured to monitor an abnormal state of a first object to be monitored. The method includes: receiving a result of detection of an abnormality detected by another monitoring device that monitors an abnormal state of a second object to be monitored that is different from the first object to be monitored; and changing a process to be performed by the monitoring device, according to the result of detection of the abnormality detected by the other monitoring device.

The computer program causes the monitoring device to more appropriately control forms of processes related to security or behaviors of the mobility, according to states of various components related to the mobility that are not monitored by the monitoring device itself.

Any combination of the exemplary embodiment and the example(s) of the modifications that are described above are also useful as exemplary embodiments of the present disclosure. Any new exemplary embodiment created by such a combination has benefits of the exemplary embodiment and the example(s) of the modifications that are combined together to create the new exemplary embodiment. It will be understood by those skilled in the art that functions that should be performed by constituent elements described in the appended claims are performed by each of components shown in the exemplary embodiment and the examples of the modifications. Alternatively, the functions are performed by the components that cooperate with each other.

The present disclosure relates to a data processing technology, and especially is useful for a monitoring device, a monitoring system, and computer readable storage medium.

What is claimed is:

1. A monitoring device that is one of a plurality of monitoring devices to be attached to mobility, the monitoring device being configured to monitor an abnormal state of a first object to be monitored, the monitoring device comprising:
a receiver configured to receive a result of detection of an abnormality detected by another monitoring device that monitors an abnormal state of a second object to be monitored that is different from the first object to be monitored; and
a controller configured to change a process to be performed by the monitoring device, according to the result of detection of the abnormality detected by the other monitoring device.

2. The monitoring device according to claim 1, wherein
the monitoring device is an entry-point device, and the first object to be monitored is an entry-point device or a network outside the mobility, and
the other monitoring device is an electronic control unit, and the second object to be monitored is an electronic control unit or a network in the mobility.

3. The monitoring device according to claim 2, further comprising
a detector configured to detect whether or not the first object to be monitored is in an abnormal state,
wherein the controller changes a detection process to be performed by the detector.

4. The monitoring device according to claim 2, further comprising
a storing portion configured to store a log that shows a result of detection of an abnormality of the first object to be monitored,
wherein the controller changes a storage process to be performed by the storing portion.

5. The monitoring device according to claim 1, wherein
the monitoring device is a first monitoring electronic control unit that monitors a first network in the mobility,
the first object to be monitored is the first monitoring electronic control unit or the first network,
the other monitoring device is a second monitoring electronic control unit that monitors a second network that is different from the first network and is in the mobility, and
the second object to be monitored is the second monitoring electronic control unit or the second network.

6. The monitoring device according to claim 5, wherein
one of the first network and the second network is an Ethernet network, and the other one is a controller area network (CAN).

7. The monitoring device according to claim 5, further comprising
a detector configured to detect whether or not the first object to be monitored is in an abnormal state,
wherein the controller changes a detection process to be performed by the detector.

8. The monitoring device according to claim 5, further comprising:
a frame receiver configured to receive a message transmitted from a device outside the monitoring device; and
a disabler configured to disable the message,
wherein the controller changes a disablement process to be performed by the disabler.

9. The monitoring device according to claim 5, further comprising
a storing portion configured to store a log that shows a result of detection of an abnormality of the first object to be monitored,
wherein the controller changes a storage process to be performed by the storing portion.

10. The monitoring device according to claim 5, further comprising
a notifying portion configured to notify, to a device outside the monitoring device, a log that shows a result of detection of an abnormality of the first object to be monitored,
wherein the controller changes a notification process to be performed by the notifying portion.

11. The monitoring device according to claim 5, wherein
the controller changes a process related to an autonomous-driving function of the mobility.

12. A monitoring system comprising:
a first monitoring device to be attached to mobility,
configured to detect whether or not a first object to be monitored is in an abnormal state, and
configured to transmit, to a second monitoring device that monitors a second object to be monitored that is different from the first object to be monitored, a result of detection of an abnormality; and
the second monitoring device to be attached to the mobility,
configured to receive the result of detection of the abnormality transmitted from the first monitoring device, and
configured to change a process to be performed by the second monitoring device, according to the result of detection of the abnormality.

13. A non-transitory computer readable storage medium recording a computer program for causing a monitoring device to execute a method, the monitoring device being one of a plurality of monitoring devices attached to mobility, the monitoring device being configured to monitor an abnormal state of a first object to be monitored, the method comprising:
receiving a result of detection of an abnormality detected by another monitoring device that monitors an abnormal state of a second object to be monitored that is different from the first object to be monitored; and
changing a process to be performed by the monitoring device, according to the result of detection of the abnormality detected by the other monitoring device.
